(19) United States
(12) Patent Application Publication
(10) Pub. No.: US 2015/0372288 A1
(43) Pub. Date: Dec. 24, 2015

(54) METHOD FOR PREPARING ANODE FOR SECONDARY BATTERY WITH IMPROVED LIFE PROPERTY

(71) Applicant: SK INNOVATION CO., LTD., Seoul (KR)

(72) Inventor: Jae-Yun MIN, Daejeon (KR)

(21) Appl. No.: 14/747,693

(22) Filed: Jun. 23, 2015

(30) Foreign Application Priority Data
Jun. 24, 2014 (KR) 10-2014-0077322

(51) Int. Cl. H01M 4/134; H01M 4/131; H01M 4/1395; H01M 4/38; H01M 4/485; H01M 4/133; H01M 4/587

(52) U.S. Cl. CPC H01M 4/134; H01M 4/133; H01M 4/131; H01M 4/587; H01M 4/386; H01M 4/485; H01M 4/1395; H01M 2004/027

(57) ABSTRACT

The present invention relates to an anode for secondary battery in which an anode current collector; a buffer layer; and an active material layer are stacked sequentially. The buffer layer of the present invention has a smaller volume change during charge and discharge than the active material layer, and separation of the active material layer from the buffer layer is prevented.

### CROSS REFERENCE TO RELATED APPLICATION

This application claims the benefit of Korean Patent Application No. 10-2014-0077322, filed on Jun. 24, 2014, entitled “METHOD FOR PREPARING ANODE FOR SECONDARY BATTERY WITH IMPROVED LIFE PROPERTY”, which is hereby incorporated by reference in its entirety into this application.

### TECHNICAL FIELD

The present invention relates to a method for preparing an anode for secondary battery with improved life property.

### BACKGROUND ART

The secondary battery is a battery capable of charging and discharging and it is used for a digital camera, an electric vehicle, a hybrid vehicle, a mobile phone and the like. These secondary batteries include nickel-cadmium batteries, nickel-metal hybrid batteries, nickel-hydrogen batteries, lithium secondary batteries and the like. Among them, the lithium secondary batteries have high operation voltage and excellent energy density property per unit weight as compared to the nickel-cadmium batteries, the nickel-metal hybrid batteries and the like. Therefore, the lithium secondary batteries are widely used in this field (see Korean Patent Application Laid-Open No. 2013-0097914, etc.).

On the other hand, conventional techniques for manufacturing a secondary battery using the silicon (Si)-based anode active material have been known, but they have problems in that the active material layer is separated from an anode current collector due to the shrinkage and expansion of Si during the cycle, thus causing a loss of electrical contact and leading to a short life of the secondary battery.

Given these circumstances, the present inventors have conducted studies on the method for increasing the life of the secondary battery, and discovered that it is possible to prevent contact of a silicon in an active material layer with an anode current collector by using a material with a small volume change rate during charge and discharge; and further that, when Si nanoparticles with a particular size as the anode active material are used together with a graphite, it is possible to prevent separation of the active material layer from an anode current collector, while maintaining the capacity of the secondary battery, thus improving the life property of the secondary battery. The present invention has been completed on the basis of such discovery.

### DISCLOSURE OF INVENTION

### Technical Problem

The present invention was made in consideration of the above described problems, and an object of the present invention is to improve the life property of the secondary battery by inhibiting separation of an active material layer.

### Technical Solution

In order to accomplish the above object, one embodiment of the present invention provides an anode for secondary battery in which an anode current collector, a buffer layer, and an active material layer are stacked sequentially.

Also, another embodiment of the present invention provides a method for preparing the anode for secondary battery.

Further, a further embodiment of the present invention provides a secondary battery comprising the above described anode for secondary battery.

### Advantageous Effects

The secondary battery of the present invention has a feature that the secondary battery inhibits separation of the active material layer from the anode current collector and that the life property is improved without deteriorating the output properties of the secondary battery.

### DESCRIPTION OF DRAWINGS

FIG. 1 shows the structure of the anode for secondary battery according to the present invention.

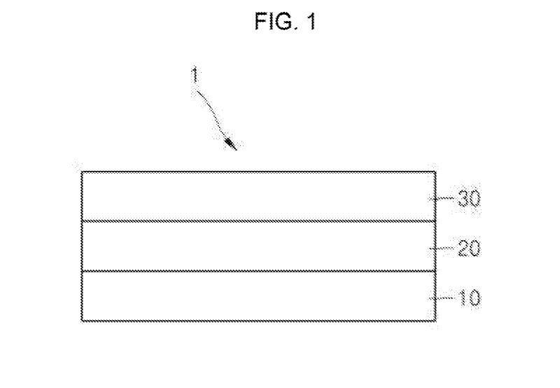

### BEST MODE

One embodiment of the present invention provides an anode for secondary battery in which an anode current collector; a buffer layer; and an active material layer are stacked sequentially.

Another embodiment of the present invention provides a secondary battery comprising an anode for secondary battery of the present invention; a cathode; an electrolyte; and a separator.

A further embodiment of the present invention provides a method for preparing an anode for secondary battery comprising preparing an anode current collector; stacking a buffer layer on the anode current collector; and stacking an active material layer on the buffer layer.

Hereinafter, the present invention will be described in detail.

Anode Current Collector (10)

The anode current collector (10) of the present invention may be an anode current collector (10) usually used in the secondary battery, but is not particularly limited thereto. For example, as the anode current collector (10) of the present invention, a copper foil can be used, but is not limited thereto.

Buffer Layer (20)

The buffer layer (20) of the present invention is coated on the anode current collector (10), thus preventing direct contact of the anode current collector (10) with the active material layer (30). In particular, the buffer layer (20) of the present invention prevents direct contact of the Si-nanoparticles in the active material layer (30) with the anode current collector (10).

The buffer layer (20) must have a smaller volume change during charge and discharge than the active material layer (30). Preferably, the buffer layer (20) has 1 to 15% by volume of volume change rate during charge and discharge. When the volume change of the buffer layer (20) exceeds 15% by volume, the adhesion strength between the anode current collector and the buffer layer is lost during the cycle, and therefore, separation occurs. At this time, the volume change is measured by the method of the following formula 1.

Volume change (%) during charge and discharge={(maximum volume during charge and discharge−minimum volume during charge and discharge)/minimum volume during charge and discharge}×100 <Formula 1>

The buffer layer (20) includes one or more materials selected from the group consisting of a graphite, a hard carbon, a soft carbon and LTO (lithium titanate oxide). Preferably, the buffer layer (20) includes one or more materials selected from the group consisting of a graphite, a hard carbon, a soft carbon and LTO (lithium titanate oxide), and a binder. The binder may be PVDF or water-based binder, i.e., SBR/CMC, and the like. Other suitable binders can be used by a person skilled in art if moving Li ions in the buffer layer (20) is possible.

Active Material Layer (30)

The active material layer (30) of the present invention includes a Si-nanoparticle, a graphite and a binder.

The Si-nanoparticle has a diameter of 5 to 45 nm. However, when the diameter of the Si nanoparticle is less than 5 nm, the initial efficiency of the secondary battery becomes low. Further, when the diameter of the Si-nanoparticle exceeds 40 nm, the Si-nanoparticle does not withstand the shrinkage and expansion thereof during the cycle of the secondary battery and finally is broken, so the life property of the secondary battery is rapidly deteriorated.

The graphite used in the active material layer (30) is mixed with the Si nanoparticle in a binder solution. At this time, the Si nanoparticle and the graphite are mixed at a weight ratio of 1:0.5 to 50 and then used. When the weight ratio of the graphite is less than 0.5, stress due to shrinkage/expansion of the active material layer is excessively increased and so contact between the Si nanoparticle and graphite is broken and finally the cycle properties are deteriorated. On the other hand, when the weight ratio of the graphite exceeds 50, the effect of improving the capacity of the secondary battery is slight.

The binder used in the active material layer (30) may include PAA (poly(acrylic acid)), PMMA (poly(methyl methacrylate)), PVA (polyvinyl alcohol), Alginate, SBR (styrene butadiene rubber), CMC (carboxymethyl cellulose), PI (Polyimide) and the like, but is not particularly limited thereto.

In the active material layer (30), a mass ratio of the Si nanoparticle and the graphite (i.e., Si nanoparticle+graphite) to the binder is 1:0.01 to 0.3. When the mass ratio of the binder is less them 0.01, the adhesive strength between graphite and Si nanoparticle and the adhesion strength between the active material layer (30) and the buffer layer (20) are very weak. Thus, it is difficult to apply the active material layer (30) to the anode current collector (10) with the buffer layer (20) coated thereon. Also, when the mass ratio of the binder exceeds 0.3, the resistance becomes stronger by the binder, and so the output properties of the secondary battery are reduced.

Anode (1)

The present invention relates to an anode (1) for secondary battery in which an anode current collector (10); a buffer layer (20); and an active material layer (30) are stacked sequentially.

Method for Preparing Anode (1)

The present invention relates to a method for preparing an anode (1) for secondary battery comprising providing an anode current collector; stacking a buffer layer on the anode current collector; and stacking an active material layer on the buffer layer.

Secondary Battery

The present invention provides a secondary battery comprising the anode (1) for secondary battery of the present invention, a cathode, an electrolyte and a separator.

Advantages and features of the present invention and methods of accomplishing the same will be apparent from the Examples and Experimental Examples which are described below in detail. However, the present invention is not limited to the embodiments and experimental examples disclosed below, and the invention will be embodied in many different forms. The Embodiments and Experimental Examples are merely provided to make the disclosure of the invention complete and to fully convey the concept of the invention to those of ordinary skill in the art to which this invention pertains, and the present invention can only be defined by the appended claims.

### EXAMPLE 1

Si nano-particles with a diameter 10 nm, graphite powders and PAA binders were prepared. The binders were dissolved in a pure water to make a binder solution. The Si nanoparticles and the graphite powders were dry-mixed at a weight ratio of 1:10. The mixture of the dry-mixed nanoparticles and the graphite powders was added to the binder solution, and then adjusted to an appropriate viscosity to produce an active material solution. In this case, (Si nanoparticle+graphite) and the binder were used at a weight ratio of 1:0.02.

Meanwhile, the graphite powders were added to a PVDF binder solution and adjusted to a viscosity suitable for coating using the NMP to prepare a buffer solution. At this time, the graphite powders and the PVDF binders were used at weight ratio of 1:0.06.

The buffer solution was coated on the cathode current collector made of a copper foil and then dried. Next, the active material solution was coated on the buffer layer and dried. Subsequently, pressing, slitting and vacuum drying processes were performed in a conventional manner to prepare an anode.

### EXAMPLE 2

The anode was prepared in the same manner as in Example 1 except that Si nanoparticle with a diameter of 35 nm was used.

### EXAMPLE 3

The anode was prepared in the same manner as in Example 1 except that (Si nanoparticles+graphite) and the binder were used at a weight ratio of 1:0.2 to prepare an active material solution.

### EXAMPLE 4

The anode was prepared in the same manner as in Example 1 except that Si nanoparticles and graphite were used at a weight ratio of 1:40.

### EXAMPLE 5

The anode was prepared in the same manner as in Example 1 except that a soft carbon instead of a graphite powder was used as a buffer layer.

### COMPARATIVE EXAMPLE 1

The anode was prepared in the same manner as in Example 1 except that Si nanoparticle with a diameter of 3 nm was used.

### COMPARATIVE EXAMPLE 2

The anode was prepared in the same manner as in Example 1 except that Si nanoparticle with a diameter of 60 nm was used.

### COMPARATIVE EXAMPLE 3

The anode was prepared in the same manner as in Example 1 except that the Si nanoparticles and graphite were used at a weight ratio of 1:0.2 to prepare an active material solution.

### COMPARATIVE EXAMPLE 4

The anode was prepared in the same manner as in Example 1 except that (Si nanoparticles+graphite) and the binder were used at a weight ratio of 1:0.6 to prepare an active material solution.

### COMPARATIVE EXAMPLE 5

Without the production of the buffer layer, the active material solution of Example 1 was directly coated on the anode current collector composed of a copper foil, and then dried. Subsequently, pressing, slitting and vacuum drying processes were performed in a conventional manner to prepare an anode.

### EXPERIMENTAL EXAMPLE 1

The aluminum foil was used as the cathode current collector, and a lithium cobaltate mixture was used as the cathode active material, to prepare a cathode. As the electrolyte, the electrolyte in which EC (ethylene carbonate) and DEC (diethyl carbonate) were mixed at a volume ratio of 25:75, and 1 mole/liter of LiPF₆ is dissolved. The secondary batteries were assembled using the cathode, the electrolyte, the separator, and the anode of each of Examples and Comparative Examples.

The charge/discharge efficiency of each of the secondary batteries was evaluated. At this time, the charge/discharge efficiency was calculated as percentage for the first discharge capacity relative to the first charge capacity.

In addition, the secondary batteries were continuously charged/discharged up to 200 cycles under 0.5 C charge and 1.0 C discharge conditions at room temperature (25° C.). Then, after 200 cycles, the capacity retention rate and occurrence of separation of the active material layer were evaluated.

As a result, it was determined that the secondary battery using the anode of Examples 1 to 5 exhibited excellent charge and discharge efficiency and capacity retention rate after 200 cycles, and further the active material layer was not separated during the charge-discharge cycle.

However, in the case of Comparative Example 1, it was found that the first charge and discharge efficiency was very low. In addition, it was determined that the secondary batteries using the anode of Comparative Examples 2, 3 and 5 exhibited very low cycle property. Among them, Comparative Example 2 showed that the Si-nanoparticle did not withstand shrinkage and expansion during the cycle of the secondary battery and finally was broken. Comparative Example 3 was thought that the content of graphite in the active material layer was very low, and therefore, contact between the Si nanoparticles and the graphite was broken. In addition, Comparative Example 5 was thought that contact between the current collector and the active material layer was broken due to lack of the buffer layer. In the case of using the anode of Comparative Example 4, it was found that output property of the secondary battery was deteriorated (Table 1).

TABLE

| | | Charge/ | | Occurrence of | |
|---|---|---|---|---|---|
| | | Discharge | Capacity | separation of | Output |
| | | Efficiency | retention | active material | property |
| | | (%) | rate (%) | layer | (W/kg) |
| Example | 1 | 85.1 | 95.1 | No separation | 2520 |
| | 2 | 86.6 | 94.3 | No separation | 2310 |
| | 3 | 84.0 | 93.2 | No separation | 2190 |
| | 4 | 87.1 | 97.5 | No separation | 2740 |
| | 5 | 84.7 | 95.1 | No separation | 2110 |
| Comparative | 1 | 71.7 | 94.9 | No separation | 3120 |
| Example | | | | | |
| | 2 | 74.3 | 65.4 | No separation | 2100 |
| | 3 | 81.1 | 51.5 | separation | 2560 |
| | 4 | 79.1 | 78.3 | No separation | 1160 |
| | 5 | 84.0 | 42.8 | separation | 2490 |

### DESCRIPTION OF REFERENCE NUMBER

1: Anode

10: Anode current collector

20: Buffer layer

30: Active material layer

What is claimed is:

1. An anode for secondary battery in which an anode current collector, a buffer layer, and an active material layer are stacked sequentially.

2. The anode for secondary battery according to claim 1, wherein the buffer layer has a smaller volume change during charge and discharge than the active material layer.

3. The anode for secondary battery according to claim 1, wherein the buffer layer has a volume change of 1 to 15% by volume daring charge and discharge.

4. The anode for secondary battery according to claim 1, wherein the buffer layer includes one or more materials selected from the group consisting of a graphite, a hard carbon, a soft carbon and LTO (lithium titanate oxide).

5. The anode for secondary battery according to claim 1, wherein the active material layer includes a Si-nanoparticle.

6. The anode for secondary battery according to claim 1, wherein the active material layer includes a Si-nanoparticle with a diameter of 5 to 45 nm.

7. The anode for secondary battery according to claim 1 wherein the active material layer includes a Si-nanoparticle, a graphite and a binder.

8. The anode for secondary battery according to claim 1 wherein the active material layer includes the Si nanoparticle and the graphite at a weight ratio of 1:0.5 to 50.

9. The anode for secondary battery according to claim 1 wherein the active material layer includes a Si-nanoparticle, a graphite and a binder, and a mass ratio of the Si nanoparticle and graphite to the binder is 1:0.01 to 0.3.

10. The anode for secondary battery according to claim 1 wherein the active material layer includes a Si nanoparticle, and the Si nanoparticle is not directly contacted with the cathode current collector.

11. A secondary battery comprising the anode for secondary battery of claim 1, a cathode, an electrolyte, and a separator.

12. A secondary battery comprising the anode for secondary battery of claim 2, a cathode, an electrolyte, and a separator.

13. A secondary battery comprising the anode for secondary battery of claim 3, a cathode, an electrolyte, and a separator.

14. A secondary battery comprising the anode for secondary battery of claim 4, a cathode; an electrolyte, and a separator.

15. A secondary battery comprising the anode for secondary battery of claim 5, a cathode, an electrolyte, and a separator.

16. A secondary battery comprising the anode for secondary battery of claim 6, a cathode, an electrolyte, and a separator.

17. A secondary battery comprising the anode for secondary battery of claim 7, a cathode, an electrolyte, and a separator.

18. A secondary battery comprising the anode for secondary battery of claim 8, a cathode, an electrolyte, and a separator.

19. A secondary battery comprising the anode for secondary battery of claim 9, a cathode, an electrolyte, and a separator.

20. A method for preparing an anode for secondary battery comprising preparing an anode current collector; stacking a buffer layer on the anode current collector; and stacking an active material layer on the buffer layer.
